(19) United States
(12) Patent Application Publication
(10) Pub. No.: US 2019/0024612 A1
(43) Pub. Date: Jan. 24, 2019

(54) ELECTRIC THROTTLE DEVICE AND CONTROLLING SYSTEM THEROF

(71) Applicant: SUZHOU CLEVA PRECISION MACHINERY & TECHNOLOGY CO., LTD., Suzhou City, Jiangsu (CN)

(72) Inventors: Zhao Kong, Suzhou City, Jiangsu (CN); Ning Guo, Jiangsu (CN)

(21) Appl. No.: 16/070,357

(22) PCT Filed: Jan. 13, 2017
(86) PCT No.: PCT/CN2017/071177

§ 371 Date: Jul. 16, 2018

(30) Foreign Application Priority Data
Jan. 15, 2016 (CN) 201610024655.1

(51) Int. Cl. F02M 1/10; F02D 11/10; F02D 9/02; F02D 41/06; F02D 41/02

(52) U.S. Cl. CPC F02M 1/10; F02D 11/10; F02D 9/02; F02B 63/02; F02D 41/065; F02D 41/067; F02D 41/021; F02D 41/064

(57) ABSTRACT

An electric throttle device and a controlling system used for a portable gasoline engine may include a rotation shaft and a throttle mounted on the rotation shaft, the throttle working to open or close the intake channel, and may further include a power unit, a transmission unit in a transmission connection with the power unit, and a controller. The transmission unit is matched with the rotation shaft, and the controller includes a circuit driving module for driving the power unit to control the opening or closing of the throttle. The electric throttle device enables co-movement of the throttle and the choker as well as automatic opening or closing.

### CROSS-REFERENCE TO RELATED APPLICATIONS

This application is a national stage of International Application No. PCT/CN2017/071177, filed on Jan. 13, 2017, which claims priority to Chinese Patent Application No. 201610024655.1, filed on Jan. 15, 2016. Both of the aforementioned applications are hereby incorporated by reference in their entireties.

### TECHNICAL FIELD

The disclosure relates to an electric throttle device and a controlling system thereof.

### BACKGROUND

Nowadays, a portable gasoline engine used for a garden tool has an intake system including an air filter, a choker, a carburetor, an intake tube, a throttle, and other parts, with its main function of using the carburetor to vaporize and mix air and fuel, in a certain proportion, into combustible gas which enters a combustion chamber through an intake channel. In an intake system of the prior art, the air passes through the air filter and the choker into a throat of the carburetor, wherein the air filter functions to filter the air and the choker functions to adjust and control the flow of the air entering the carburetor. The carburetor is provided, at its throat, with a device for adjusting the flow of the fuel entering the throat. The air and the fuel come together at the throat, and due to the venturi tube effect, the fuel is vaporized and mixed with the air into the combustible gas mixture which then passes through the carburetor, the intake tube and the intake valve, and finally into the combustion chamber.

When the portable gasoline engine is started, especially at a relatively low ambient temperature, it is required to increase the fuel concentration in the fuel-gas mixture introduced into the combustion chamber, in order to facilitate starting the gasoline engine. That is, on one hand, it is required to increase the flow of the fuel of the carburetor; and on the other hand, it is required to decrease the amount of the air introduced into the carburetor. However, in the prior art, in order to decrease the amount of the intake air, it is a commonly used method for the operator to manually close the choker according to the temperature of the use environment, thus decreasing the amount of the intake air. In such method, the operator needs to make a decision according to the ambient temperature in order to manually operate to close the choker, and also needs to re-open the choker when the gasoline engine is normally working. In the whole process, the manual operation is quite complicated, with a certain skill requirement on the operator, which is adverse to the popularization and promotion of the product.

In addition, the user who is using the portable gasoline engine, after the gasoline engine is started, often forgets to open the choker and directly increases the throttle, resulting in stalling of the gasoline engine due to insufficient intake. Though the devices linking the throttle and the choker for co-movement have been developed by many companies in China and abroad, they have defects of complicated structure, poor reliability, insensitive response, etc.

### SUMMARY

The technical problem to be solved by the disclosure is to provide an electric throttle device and a controlling system thereof, wherein the operation is simple and convenient, without requirement for skills and experiences on the operators, enabling better use experience for the users and facilitating popularization and promotion of the product.

A first technical solution of the disclosure is: an electric throttle device, used for a portable gasoline engine which includes a body, a cylinder provided in the body, and a carburetor provided at a side of the cylinder and with an intake channel; the electric throttle device includes a rotation shaft and a throttle mounted on the rotation shaft, the throttle working to open or close the intake channel; the electric throttle device further includes a power unit, a transmission unit in a transmission connection with the power unit, and a controller; wherein the transmission unit is matched with the rotation shaft, and the controller is provided with an circuit driving module for driving the power unit to control the opening or closing of the throttle.

Based on the first technical solution, the following dependent technical solutions are further included.

The transmission unit cooperates with an end of the rotation shaft via a throttle pull rod for movement, and the throttle and the rotation shaft are rotated coaxially.

The transmission unit includes a rack, and a gear cooperating with the rack and connected to an output of the power unit.

The power unit is an electric motor, or a combination of an electric motor and a gearbox, or in an electric-magnetic form, or in a pneumatic form.

The electric motor is a DC (Direct Current) or AC (Alternating Current) electric motor enabling bidirectional rotation.

The electric throttle device further includes a temperature sensor connected with the controller, and a choker controlling device connected with the controller, wherein the choker controlling device includes a choker shaft and a choker mounted on the choker shaft, the choker working to open or close the intake channel and the choker shaft being parallel to the rotation shaft.

The controller employs a hot-start mode and opens the choker when the ambient temperature is higher than a preset value, and employs a cold-start mode and closes the choker when the ambient temperature is lower than a preset value.

The choker shaft is driven by another power unit, wherein the choker is located at an intake end of the intake channel while the throttle is located at an exhaust end of the intake channel.

The electric throttle device further includes a rotation end and an unlocking end which are located at the two ends of the rotation shaft, respectively, wherein the rotation end is fixed to a throttle pull rod and the unlocking end cooperates with the choker controlling device for movement, and the throttle is opened to drive the choker to open.

A second technical solution of the disclosure is: an electric throttle controlling system, including a rotation shaft provided on a carburetor, and a throttle provided on the rotation shaft and used for opening or closing an intake channel of the carburetor; the electric throttle controlling system includes a power unit, a DC power source providing energy to the power unit, a transmission unit in a transmission connection with the power unit, a controller for controlling power output of the power unit, and a manipulator in wireless communication with the controller, wherein the controller is provided with an circuit driving module for driving the power unit and controlling the opening or closing of the throttle, and a wireless communication module for receiving a wireless signal from the manipulator.

A third technical solution of the disclosure is: an electric throttle controlling system, including a rotation shaft provided on a carburetor, and a throttle provided on the rotation shaft and used for opening or closing an intake channel of the carburetor; the electric throttle controlling system includes a power unit, a DC power source providing energy to the power unit, a transmission unit in a transmission connection with the power unit, a controller for controlling power output of the power unit, and a manipulator in wireless communication with the controller, wherein the controller is provided with an circuit driving module for driving the power unit and controlling the opening or closing of the throttle, the manipulator and the controller are separated from each other and are connected for controlling via a signal line to each other.

In the disclosure, the controller is used, by controlling the power unit (servo motor) and in cooperation with the temperature sensor, to control and adjust opening or closing of the choker, achieving the co-movement of the throttle and the choker, so as to control the flow of the air entering the carburetor. Further, the controller is used, by controlling the servo motor, to control and adjust the fuel flow adjusting device on the carburetor, so as to adjusting the flow of the fuel of the carburetor. Therefore, free adjustment of the mixture ratio of the fuel to the air in various situations is enabled, while it can not be freely adjusted in the prior art. With free adjustment, it is advantageous to adjust the fuel concentration as required. For example, in cold start, it is possible to increase the fuel concentration to facilitate starting of the gasoline engine. Moreover, it is possible to freely set the fuel concentration under various load conditions to improve fuel efficiency and reduce emission. In addition, in the disclosure, the throttle and the choker can be opened or closed automatically. The operation is simple and convenient, without requirement for skills and experiences on the operators. It provides a simple structure, high reliability, and sensitive response, thus enabling better use experience for the users and facilitating popularization and promotion of the product.

### BRIEF DESCRIPTION OF DRAWINGS

FIG. 1 is a sectional view of a first embodiment according to certain aspects of a portable gasoline engine of the disclosure;

FIG. 2 is a partial isometric view of the engine of FIG. 1;

FIG. 3 is an exploded view of elements of FIG. 2;

FIG. 4 is a sectional view of FIG. 2, in an idling state;

FIG. 5 is a sectional view of FIG. 2, in a high speed state;

FIG. 6 is a modular diagram showing the functions of an electric circuit according to certain aspects of the disclosure;

FIG. 7 is an electric circuit diagram of the controller of the disclosure;

FIG. 8 is an electric circuit diagram of the power source module of the disclosure;

FIG. 9 is an electric circuit diagram of the high voltage ignition unit of the disclosure;

FIG. 10 is an electric circuit diagram of the choker and the throttle controlling unit of the disclosure; and

FIG. 11 is an electric circuit diagram of the electric-starting controlling unit of the disclosure.

### DETAILED DESCRIPTION

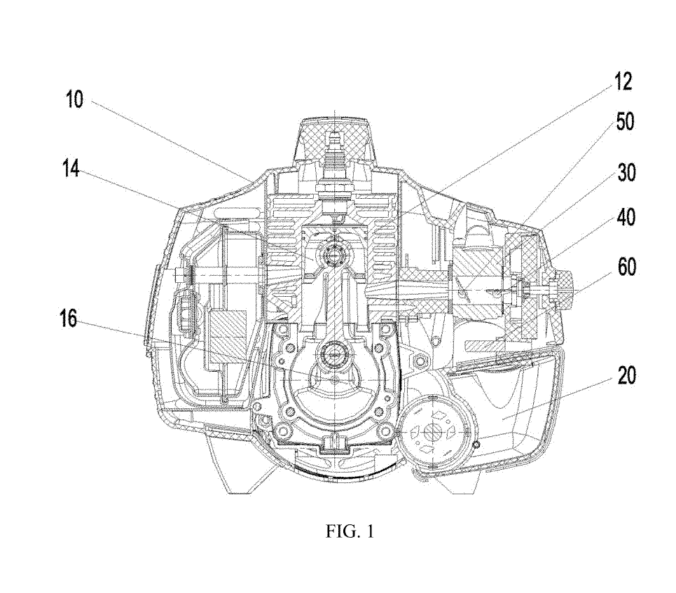

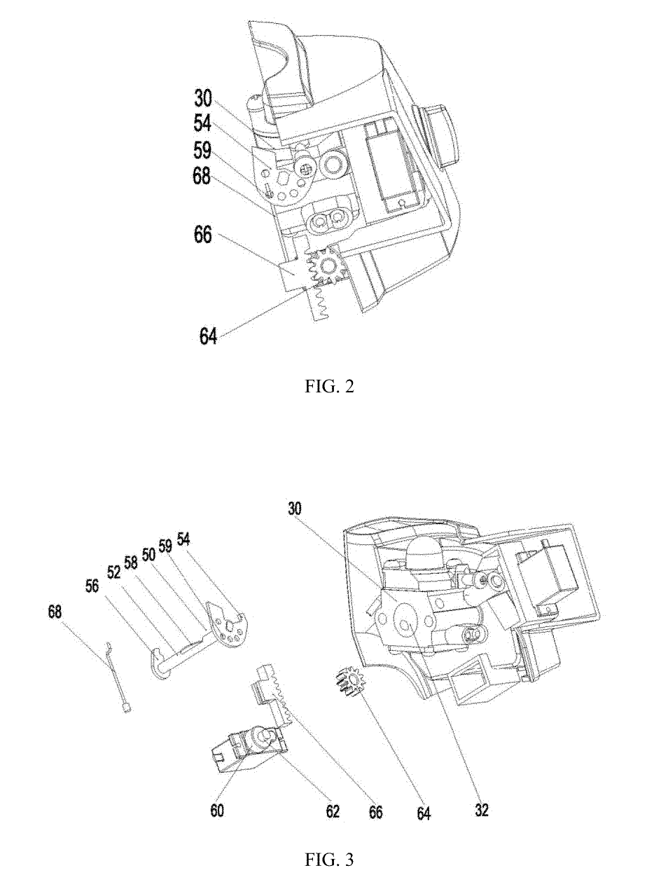

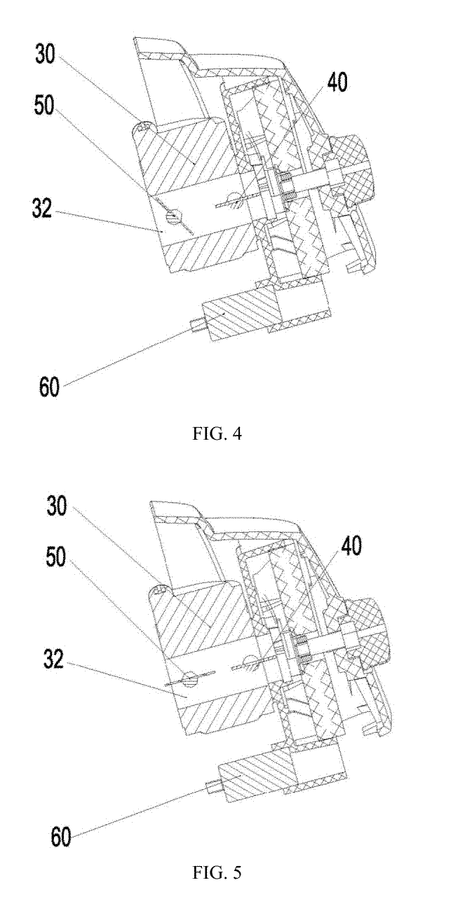

As shown in FIGS. 1-5, a first embodiment of an electric throttle device is depicted, as used for a portable gasoline engine which includes a body 10, a cylinder 12 located in the body 10, a piston 14 located in the cylinder 12, a crankshaft 16 linked with the piston 14 for co-movement, a fuel tank 20 located on the body 10, a carburetor 30 located at a side of the cylinder 12 and with an intake channel 32, a choker controlling device 40 located on the carburetor 30, an electric throttle controlling device 50 located on the carburetor 30. The electric throttle device 50 includes a rotation shaft 52 and a throttle 58 mounted on the rotation shaft 52, the throttle 58 working to open or close the intake channel 32. The electric throttle device 50 further includes a power unit 60, a transmission unit in a transmission connection with the power unit 60, and a controller. The transmission unit is matched with the rotation shaft 52, and the controller is provided with an circuit driving module for driving the power unit to control the opening or closing of the throttle 58.

The transmission unit cooperates with an end of the rotation shaft 52 via a throttle pull rod 68 for movement, and the throttle 58 and the rotation shaft 52 are rotated coaxially. The transmission unit includes a rack 66 fixed to the throttle pull rod 68, and a gear 64 cooperating with the rack 66 and connected to an output of the power unit 60. Likewise, the transmission unit may directly cooperate with an end of the rotation shaft for movement, which is also possible to achieve the purpose of the disclosure. According to the disclosure, the rack and gear transmission structure used in the transmission unit is simple, reliable, and low-cost. It is also possible to use a transmission type with a band, a chain, a hinge, or a swing rod, to achieve the purpose of the disclosure.

Preferably, the electric throttle device 50 further includes a temperature sensor connected with the controller, and a choker-controlling device connected with the controller, wherein the choker controlling device includes a choker shaft and a choker mounted on the choker shaft, the choker working to open or close the intake channel 32 and the choker shaft being parallel to the rotation shaft. Preferably, the controller employs a hot-start mode and opens the choker when the ambient temperature is higher than a preset value, and employs a cold-start mode and closes the choker when the ambient temperature is lower than a preset value. Preferably, the choker shaft is driven by another power unit, wherein the choker is located at an intake end of the intake channel 32 while the throttle 58 is located at an exhaust end of the intake channel 32.

Preferably, the electric throttle device further includes a rotation end 54 and an unlocking end 56 which are located at the two ends of the rotation shaft 52, respectively, wherein the rotation end 54 is fixed to the throttle pull rod 68 and the unlocking end 56 cooperates with the choker controlling device for movement. The throttle 58 is opened to drive the choker to open, thus achieving co-movement of the throttle 58 and the choker. The rotation end 54 is at least partially in a circular arc shape, and is provided with several fixing holes 59 arranged in an arc shape, wherein one of the fixing holes 59 is fixed to an end of the throttle pull rod 68 by snap-fitting.

The power unit 60 is preferably an electric motor, or a combination of an electric motor and a gearbox, or in an electric-magnetic form, or in a pneumatic form. The electric motor is preferably a DC or AC electric motor enabling bidirectional rotation, and is also referred as servo motor. In the present embodiment, it is preferably a DC servo electric motor, enabling a compact structure, a large torque and a programmable controlling.

The carburetor 30 is located at a side of the cylinder 12 and above the fuel tank 20. The carburetor 30 is connected, via a gas deliver channel, with the cylinder 12. The cylinder 12 is provided therein with a combustion chamber into which a mixture of fuel and gas is introduced for combustion.

Therefore, according to the aspects of the disclosure, the throttle 58 is fixed on the rotation shaft 52 and can be rotated together with the rotation shaft 52, and the rotation shaft 52 is mounted in the intake channel 32 inside the carburetor 30. When the gasoline engine is in the idling state, the throttle 58 is in the closed position, and the controller controls the power unit 60 to work and drives the gear 64 to rotate via the output shaft 62, thus driving the rack 66 to move linearly, which in turn drives the throttle pull rod 68 to move linearly. As the throttle pull rod 68 is connected with the rotation end 54, the rotation end 54 drives the rotation shaft 52, located at its center, to rotate together, bringing the throttle 58 to the opening position. Then, the unlocking end 56 opens the choker by co-movement to increase the amount of intake air, thus the gasoline engine comes into the high speed state, achieving the automatic controlling of the choker controlling device and the electric throttle device.

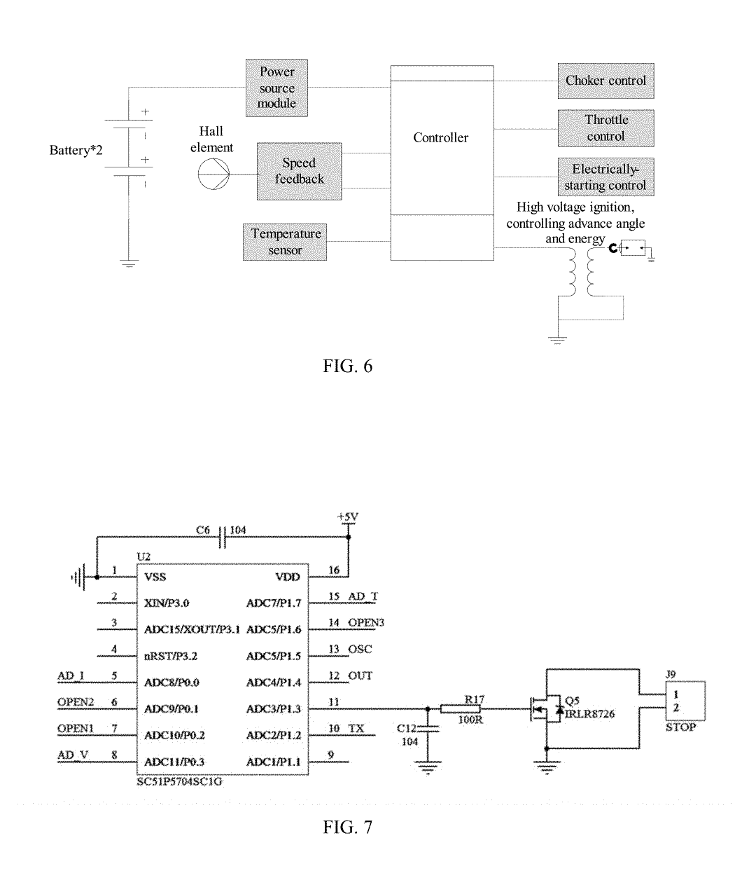

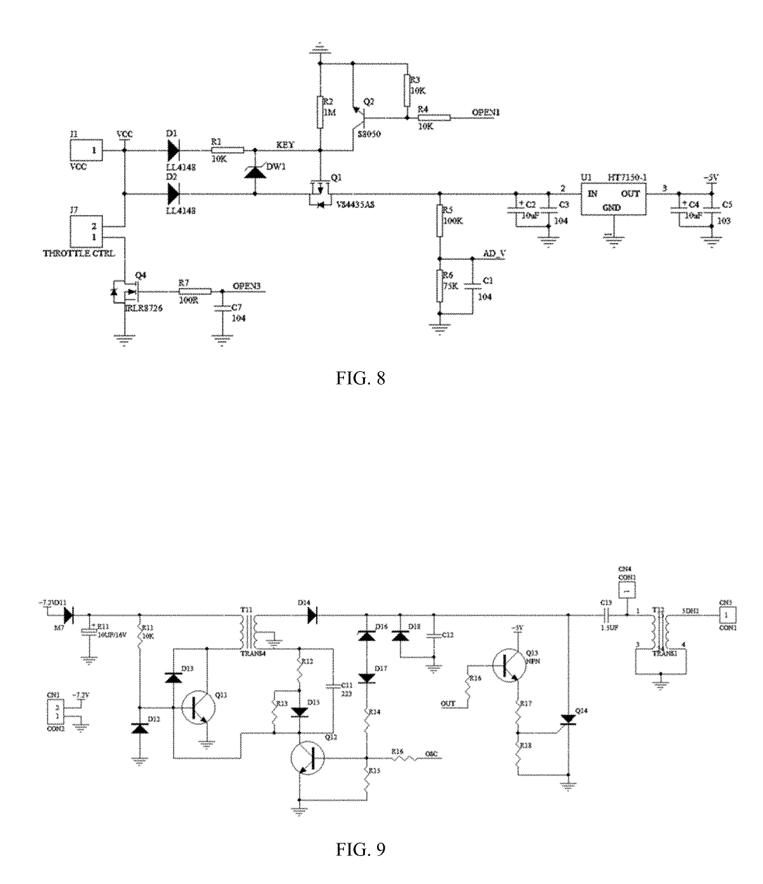

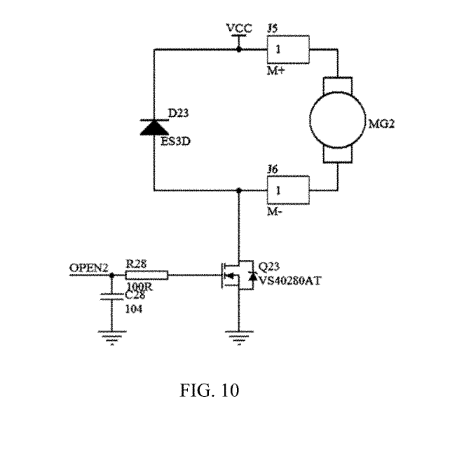

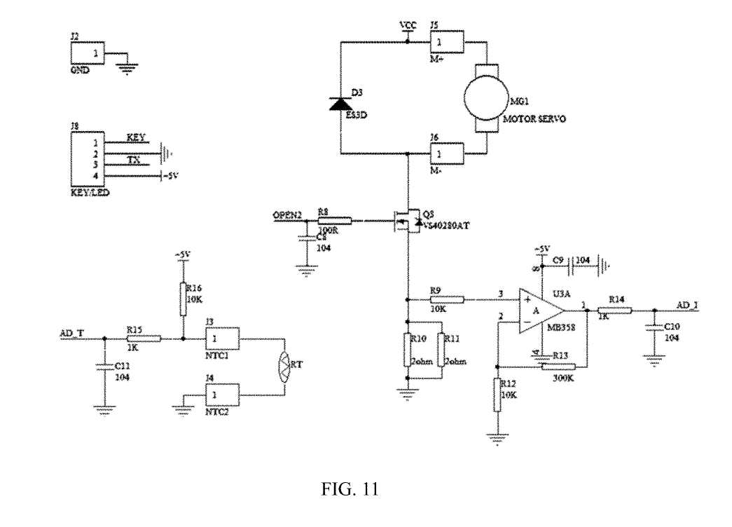

As shown in FIGS. 6-11, according to aspects of the disclosure, a second embodiment of an electric throttle controlling system is also provided, including a power source, a power source module connected with the power source and used for voltage reduction, a controller connected with the power source module and controlling the running of the power unit, and a temperature sensor connected with the controller, a choker controlling unit connected with the controller, a throttle controlling unit connected with the controller, an electric-starting controlling unit connected with the controller, a high voltage ignition unit connected with the controller, a speed feedback unit connected with the controller and with a Hall element, and a temperature sensor connected with the controller. The high voltage ignition unit includes an ignition coil, a spark plug, and other elements. In this case, the power source is preferably a removable rechargeable battery, more preferably a Li-ion battery, and also provides energy to the power unit. The controller is a PLC (Programmable Logic Controller). The controller at least includes a circuit driving module connected with the electric motor, a temperature sensor module, and an angle module for controlling the rotation angle of the choker, wherein the controller is provided therein with a main chip circuit and its electric circuit structure is specifically detailed in FIG. 7, the electric circuit inside the power source module is specifically detailed in FIG. 8, the electric circuit structure of the high voltage ignition unit is specifically detailed in FIG. 9, the electric circuit structure of the choker and the throttle controlling unit is specifically detailed in FIG. 10, and the electric circuit structure of the electric-starting controlling unit is specifically detailed in FIG. 11. Therefore, the ambient temperature is detected by the temperature sensor. Once the ambient temperature is lower than the preset value, in starting, the concentration of the fuel in the fuel-gas mixture to be introduced into the combustion chamber is increased, that is, the amount of the air to be introduced into the carburetor is decreased, so as to automatically close the choker by the controller controlling the rotation of the electric motor. When the gasoline engine is normally working, the choker and the throttle are re-opened automatically. The whole process is simple and convenient, enabling automatic setting of the starting state of the gasoline engine in various starting situations, reducing interference to the starting process of the gasoline engine from the operator who is starting it, and also alleviating the labor intensity of the operator.

Certainly, the above embodiments are provided only to explain the technical concepts and features of the disclosure, with the purpose for enabling those skilled in the art to implement the disclosure by understanding the contents thereof, rather than limiting the protection scope of the disclosure thereto. Any equivalent alternative or modification made to the main technical solutions of the disclosure based on the substantial spirit of the disclosure will fall within the protection scope of the disclosure.

1. An electric throttle device for a portable gasoline engine including a body, a cylinder located in the body, and a carburetor located at a side of the cylinder and with an intake channel, the electric throttle device comprising:
a rotation shaft;
a throttle mounted on the rotation shaft, the throttle working to open or close the intake channel;
a power unit; a transmission unit in a transmission connection with the power unit;
a controller;
the transmission unit being matched with the rotation shaft, and the controller including a circuit driving module for driving the power unit to control opening or closing of the throttle;
a temperature sensor connected with the controller; and
a choker controlling device connected with the controller.

2. The electric throttle device of claim 1, wherein the transmission unit cooperates with an end of the rotation shaft via a throttle pull rod for movement, and the throttle and the rotation shaft are rotated coaxially.

3. The electric throttle device of claim 2, wherein the transmission unit comprises a rack fixed to the throttle pull rod, and a gear cooperating with the rack and connected to an output of the power unit.

4. The electric throttle device of claim 3, wherein the power unit is any one of an electric motor, a combination of an electric motor and a gearbox, an electric-magnetic power unit, or a pneumatic power unit.

5. The electric throttle device of claim 4, wherein the choker controlling device comprises a choker shaft and a choker mounted on the choker shaft, the choker working to open or close the intake channel and the choker shaft being parallel to the rotation shaft; and wherein the controller employs a hot-start mode and opens the choker when the ambient temperature is higher than a preset value, and employs a cold-start mode and closes the choker when the ambient temperature is lower than a preset value.

6. The electric throttle device of claim 5, wherein the choker shaft is driven by another power unit, wherein the choker is located at an intake end of the intake channel while the throttle is located at an exhaust end of the intake channel.

7. The electric throttle device of claim 5, wherein the electric throttle device further comprises a rotation end and an unlocking end which are located at two ends of the rotation shaft, respectively, wherein the rotation end is fixed to the throttle pull rod and the unlocking end cooperates with the choker controlling device for movement, and the throttle is opened to drive the choker to open.

8. The electric throttle device of claim 7, wherein the rotation end is at least partially in a circular arc shape, and defines several fixing holes arranged in an arc shape, wherein one of the fixing holes is fixed to an end of the throttle pull rod by snap-fitting.

9. An electric throttle controlling system for a rotation shaft located on a carburetor, with a throttle located on the rotation shaft and used for opening or closing an intake channel of the carburetor, the electric throttle controlling system comprising:
a power unit;
a DC power source providing energy to the power unit;
a transmission unit in a transmission connection with the power unit;
a controller for controlling power output of the power unit; and
a manipulator in wireless communication with the controller;
the controller including a circuit driving module for driving the power unit and controlling the opening or closing of the throttle, the controller also including a wireless communication module for receiving a wireless signal from the manipulator.

10. An electric throttle controlling system for a rotation shaft located on a carburetor, and with a throttle located on the rotation shaft and used for opening or closing an intake channel of the carburetor, the electric throttle controlling system comprising:
a power unit;
a DC power source providing energy to the power unit;
a transmission unit in a transmission connection with the power unit;
a controller for controlling power output of the power unit; and
a manipulator in wireless communication with the controller
the controller including a circuit driving module for driving the power unit and controlling the opening or closing of the throttle;
the manipulator and the controller being separated from each other and being connected to each other for controlling via a signal line.
